(19) United States
(12) Patent Application Publication
(10) Pub. No.: US 2024/0177623 A1
(43) Pub. Date: May 30, 2024

(54) Connected home integrated homework "tutoring" and auto-grading service

(71) Applicant: DISH Network L.L.C., Englewood, CO (US)

(72) Inventors: Caroline Elizabeth Condon, Denver, CO (US); Amber Bellerjeau, Littleton, CO (US); Luke VanDuyn, Conifer, CO (US)

(73) Assignee: DISH Network L.L.C., Englewood, CO (US)

(21) Appl. No.: 18/070,697

(22) Filed: Nov. 29, 2022

(51) Int. Cl. G09B 7/04

(52) U.S. Cl. CPC G09B 7/04

(57) ABSTRACT

An educational service for tutoring, testing, and auto-grading is provided within a computer network. A first computing or smart device connected within the computer network is controlled to present a test question using an output component of the computing or smart device. Either the first computing or smart device or a second computing or smart device connected within the computer network is controlled to receive a response to the test question using an input component of either the first or second computing or smart device. The received response by the input component is transformed into a digital file. A recognition algorithm is applied to the digital file of the received response to parse the received response. The parsed received response is processed to determine an accuracy of the response to the test question.

### TECHNICAL FIELD

The technology described herein relates to automated tutoring, testing and grading devices, systems and processes.

### BACKGROUND

Young students typically learn basic language and math skills through repetitive drills and immediate feedback. For example, spelling of words begins with introduction of phonics elements and then students are presented with spelling tests. Similarly, instruction of basic math skills is often conducted using “tables” of simple arithmetic problems (e.g., addition, subtraction, multiplication, division of numbers≤20) with a goal to achieve rote memory. However, it can be difficult for kids to practice these memory drills on their own, particularly with respect to spelling—they need someone to read the words for testing. When at home, busy parents may not have time to work with their children enough to adequately instill the necessary skills. When parents use a primary language that is not the primary language taught in school (e.g., English in the United States), it may be difficult for them to provide proper pronunciation of words or understand language rules to provide reinforcing instruction. Further, although tutoring applications exist, e.g., on smart phone devices, parents may not want younger children to have a smartphone or to use one during “homework time,” due to the opportunities for distraction. Additionally, burdens on formal classroom instruction may impact the ability of teachers to provide adequate reinforcement to create a solid foundation and understanding. For example, teachers are often frustrated with the logistical burden of grading and tracking homework results and in-class testing leaves less time for instruction.

### SUMMARY

In one example implementation, a method is implemented within a computer network for providing an educational service. A first device may be connected within the computer network and controlled to present a test question using an output component of the first device. Either the first device, or a second device connected within the computer network, may be controlled to receive a response to the test question using an input component of either the first device or the second device. The received response may be transformed by the input component into a digital file. A recognition algorithm may be applied to the digital file of the received response to parse the received response. The parsed received response may be processed to determine an accuracy of the response to the test question.

In an additional example implementation of the method, a grade corresponding to the determined accuracy of the response to the test question may be calculated.

In another implementation of the method, a plurality of parsed received responses may be stored in a non-transitory storage medium as a collection of parsed received responses. The collection of parsed received responses may be analyzed to identify patterns indicating poor understanding of a skill. A tutoring presentation may then be provided.

In a further example implementation of the method, the output component may be a loudspeaker and the test questions may be presented as audible output from the loudspeaker.

In yet another example implementation of the method, the output component may be a video screen and the test questions may be presented in an image in the video screen.

In yet a further example implementation of the method, the input component may be a microphone. The test answers may be received as an audible response through the microphone and the recognition algorithm may be a speech recognition algorithm.

In an additional example implementation of the method, the input component may be a camera. The test answers may be received as an image of a written response by the camera and the recognition algorithm may be a handwriting recognition algorithm.

In another example implementation, a system provides an educational service on a computer network. The system includes a computing processor and a memory storage device that stores instructions for directing the computing processor to execute a control algorithm including a number of modules. A device control module stored in the memory storage device and executable by the computing processor configures the system to control a first computing or smart device connected within the computer network to present a test question using an output component of the computing or smart device and to control either the first computing or smart device or a second computing or smart device connected within the computer network to receive a response to the test question using an input component of either the first or second computing or smart device. A file manager module stored in the memory storage device and executable by the computing processor configures the system to transform the received response by the input component into a digital file. A recognition module stored in the memory storage device and executable by the computing processor configures the system to apply a recognition algorithm to the digital file of the received response to parse the received response. A grading module stored in the memory storage device and executable by the computing processor is configured to process the parsed received response to determine an accuracy of the response to the test question.

In another example implementation of the system, the grading module may further configure the system to calculate a grade corresponding to the determined accuracy of the response to the test question.

In a further example implementation of the system, a database module stored in the memory storage device and executable by the computing processor may configure the system to store a plurality of parsed received responses in a non-transitory storage medium as a collection of parsed received responses. The grading module may further configures the system to analyze the collection of parsed received responses to identify patterns indicating poor understanding of a skill and provide a tutoring presentation by leveraging the file manager module to provide the tutoring presentation and by leveraging the device control module to control either the first computing or smart device or the second computing or smart device to present the tutoring presentation on either the first computing or smart device or the second computing or smart device.

In a further example implementation of the system, the output component may further include a loudspeaker and the test questions may be presented as audible output from the loudspeaker.

In another example implementation of the system, the output component may further include a video screen and the test questions may be presented in an image in the video screen.

In yet another example implementation of the system, the input component may further include a microphone and the test answers may be received as an audible, oral response via the microphone and the recognition algorithm may be a speech recognition algorithm.

In yet a further example implementation of the system, the input component may further include a camera and the test answers may be received as an image of a written response by the camera and the recognition algorithm may be a handwriting recognition algorithm.

In a further example implementation, a tangible processor-readable storage media may be embedded with instructions for executing a process on a computing device to provide an educational service. A first computing or smart device connected within a local area network may be controlled to present a test question using an output component of the computing or smart device. Either the first computing or smart device, or a second computing or smart device connected within the local area network, may be controlled to receive a response to the test question using an input component of either the first or second computing or smart device. The received response may be transformed by the input component into a digital file. A recognition algorithm may be applied to the digital file of the received response to parse the received response. The parsed received response may be processed to determine an accuracy of the response to the test question.

In another example implementation of the tangible, processor-readable storage media, as part of the process, a grade corresponding to the determined accuracy of the response to the test question may be calculated.

In another example implementation of the tangible, processor-readable storage media, as part of the process, a plurality of parsed received responses may be stored in a non-transitory storage medium as a collection of parsed received responses. The collection of parsed received responses may be analyzed to identify patterns indicating poor understanding of a skill. A tutoring presentation may then be provided.

In another example implementation of the tangible, processor-readable storage media, the output component may further include one of a loudspeaker or a video screen and the test questions are presented as audible output from the loudspeaker or in an image in the video screen.

In another example implementation of the tangible, processor-readable storage media, the input component may further include a microphone and the test answers may be received as an audible, oral response via the microphone, and the recognition algorithm may be a speech recognition algorithm.

In another example implementation of the tangible, processor-readable storage media, the input component may further include a camera and the test answers may be received as an image of a written response via the camera, and the recognition algorithm may be a handwriting recognition algorithm.

### BRIEF DESCRIPTION OF THE DRAWINGS

The disclosure will be readily understood by the following detailed description in conjunction with the accompanying drawings, wherein like reference numerals designate like structural elements. The proportions and dimensions (either relative or absolute) of the various features and elements (and collections and groupings thereof) and the boundaries, separations, and positional relationships presented therebetween, are provided in the accompanying figures to facilitate an understanding of the various embodiments described herein and, accordingly, may not necessarily be presented or illustrated to scale, and are not intended to indicate any preference or requirement for an illustrated implementation to the exclusion of implementations described with reference thereto.

FIG. 1 is a schematic illustration of a tutoring, testing, and auto-grading educational application executed on a computing device and related network interactions and in accordance with at least one implementation of the present disclosure.

FIG. 2 is a schematic illustration of a tutoring, testing, and auto-grading educational application in a network environment and in accordance with at least one implementation of the present disclosure.

FIG. 3 is a schematic illustration of a tutoring, testing, and auto-grading educational application in an extended educational service environment and in accordance with at least one implementation of the present disclosure.

FIG. 4 is a schematic illustration of a combination of logical software modules implemented with the extended educational service environment of FIG. 4 and in accordance with at least one implementation of the present disclosure.

FIG. 5 is a flow diagram of a process providing a tutoring, testing, and auto-grading educational service environment and in accordance with at least one implementation of the present disclosure.

FIG. 6 is a schematic diagram of a tutoring, testing, and auto-grading educational system and in accordance with at least one implementation of the present disclosure.

### DETAILED DESCRIPTION

For at least one implementation of the present disclosure, a tutoring, testing, and automatic grading system (herein, a “TTAGS” and also referred to as “the system”) assists students with educational instruction for one or more types of rote instruction activities, with non-limiting examples including, spelling rules and strategies and elementary math tables. The TTAGS enables students to work on rote learning skills independently. For at least one implementation, a TTAGS tests accuracy of knowledge in one or more educational disciplines, identifies areas of low proficiency, provides reinforcement in problem areas to improve proficiency, and provides automatic test grading and scoring. The TTAGS may collect data and provide grades and individual proficiency reports for students which enable teachers to identify issues on which to focus lessons during classroom instruction time and otherwise. The TTAGS can be implemented using known and later arising computing and network environments and technologies. The following discussion presents non-limiting example implementations for system configurations, which embody non-limiting implementations of the TTAGS. For purposes of simplicity, these example implementations are described in the context of spelling instruction and testing; however, a TTAGS supports other types of instruction and subject matter tutoring, testing, and grading.

“Cloud” refers to cloud computing, cloud storage, cloud communications, and/or other technology resources which a given user does not actively manage or provide. A usage of a Cloud resource may be private (limited to certain users and/or uses), public (available for users and/or uses), hybrid, dedicated, non-dedicated, or otherwise. It is to be appreciated that implementations of the present disclosure may use Cloud resources to provide for processing, storage and other functions related to facilitating live cell phone watch parties.

“Device” refers to an electronic device configured to communicate data to and/or from a destination using a wired and/or wireless communications technology. A device may include and/or be communicatively coupled to one or presentation devices, such as a display device, audible output device, or otherwise. Non-limiting examples of devices include smart phones, smart televisions, tablet computing devices, lap-top computers, desk-top computers, gaming consoles, cable/satellite set-top-boxes (STB), 10-Foot presentation devices, Internet-of-Things (“IoT”) devices, and the like. For at least one implementation, a device utilizes a wireless communications technology service provided by a Mobile Network Operator (“MNO”). A non-limiting list of MNOs include DISH Network, A&T, Verizon, T-Mobile in the United States and other MNOs worldwide, such as ORANGE, TELEKOM, O2, VODAFONE, and others.

An “Application” is a set of computer instructions that configure a processor perform one or more tasks that are other than tasks commonly associated with the operation of the processor itself (e.g., a “system software,” an example being an operating system software), or the providing one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like.

“Coupling” refers to establishment of a communications link between two or more elements of a given system. A coupling may utilize any known and/or later arising communications and/or networking technologies, standards, protocols or otherwise. Non limiting examples of such technologies include packet switch and circuit switched communications technologies, such as and without limitation, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used including, without limitation, the TCP/IP suite of protocols, the Extensible Message and Presence Protocol (XMPP), VOIP, Ethernet, Wi-Fi, CDMA, Z WAVE, Near Field Communications (NFC), GSM/GRPS, TDMA/EDGE, EV/DO, WiMAX, SDR. LTE, MPEG, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Module” recites definite structure for an electrical/electronic device that is configured to provide at least one feature and/or output signal and/or perform at least one function including the features, output signals and functions described herein. A module may provide the one or more functions using computer engines, processors, computer instructions and the like. When a feature, output signal and/or function is provided, in whole or in part, using a processor, one more software components may be used, and a given module may include a processor configured to execute computer instructions. A person of ordinary skill in the art (a “POSITA”) will appreciate that the specific hardware and/or computer instructions used for a given implementation will depend upon the functions to be accomplished by a given module. Likewise, a POSITA will appreciate that such computer instructions may be provided in firmware, as embedded software, provided in a remote and/or local data store, accessed from other sources on an as provided basis, or otherwise. Any known or later arising technologies may be used to provide a given module and the features and functions supported therein.

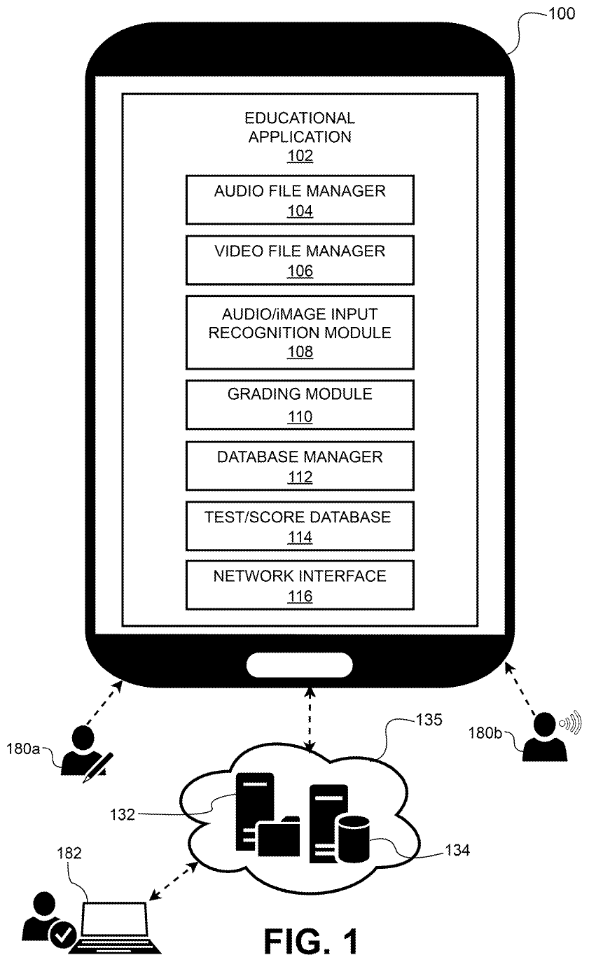

Although, as noted, parents may have concerns about allowing young children to independently use a computing device 100 such as a smart phone, tablet computer, or laptop computer, a simple example implementation of the tutoring, testing, and auto-grading system is through an educational application 102 instantiated on a computing device 100 as shown in FIG. 1. The educational application 102 may facilitate practice spelling tests, for example, by reading out, e.g., audibly outputting via a voice emulation function of the computing device 100 through a loudspeaker, a preconfigured list of words, or by playing a prerecorded audio file presenting a listing of test words. A first student 180a may be instructed to spell the words by writing the words on a piece of paper and then taking a photograph of the answers on the paper using a camera function of the computing device 100. The written answers of the first student 180a may be interpreted by a handwriting/text recognition function of the computing device 100 and compared to the correct spellings of the words on the list.

For at least one implementation, a second student 180b could audibly respond to the audible output of the word list by orally attempting to spell each word. The computing device 100 may save the oral spelling of the second student 180b in an audio file that can be analyzed by a speech recognition function of the computing device 100 to identify the letters spoken. The educational application 102 may then compare the determined letters to the correct spelling of the words on the list.

In at least one implementation, the educational application 102 may grade the given test based upon accuracy of the student's answers and store the results in a data file on the computing device 100. The educational application 102 can determine spelling proficiency and identify patterns that can reflect issues with spelling and language constructs with which the student appears to have difficulty. The educational application 102 can offer immediate feedback and provide a chance for students to correct their work. For example, the educational application may respond to an attempted, but inaccurate, word spelling by stating, “You spelled “enough” with an “f”; but the “f” sound is actually made by a “gh” in this word, just like in “cough.” Sch feedback may be provided through the voice emulation function or by accessing and presenting a prerecorded video or audio file addressing the particular subject or issue identified,

As shown in FIG. 1 and for at least one implementation, the educational application 102 can utilize one or more base functionalities of the computing device 100 to provide features and functions of a TTAGS. For a non-limiting example, an audio file manager 104 may access a local library of audio files that present a list of test words for a student to spell, e.g., by writing on paper or through an oral spelling response. A video file manager 106 may access a local library of instructional videos related to the lessons or concepts being tested. Such videos may be viewed by the student in advance of taking a test on a particular concept or may be offered to the student upon determination that the student is having difficulty with a concept as indicated by test results.

For at least one implementation, the educational application 102 may include an audio/image recognition module 108 that leverages a microphone of the computing device 100 to receive oral input of answers from a student or leverages a camera of the computing device 100 to receive an image of written test results. A computing device 100 may utilize integrated hardware and software, and/or external hardware and software, to receive and process audio input and images, the audio/image recognition module 108 may receive the input data (e.g., test answers) provided by the computing device 100 and manage such input for the purposes of the educational application 102. For a non-limiting example, the audio/image recognition module 108 may parse and configure the input data for grading and analysis purposes.

The educational application 102 may include a grading module 110 that interacts with the audio/image recognition module 108 to receive the test answers and other input data. The grading module 110 compares the test answers received to a glossary of the tested words, e.g., by leveraging spellchecking technologies used in word processing programs. The grading module 110 may identify areas of difficulty exhibited in the nature of student errors in the test answers. Known and/or later arising pattern recognition and similar intelligent processing capabilities may be utilized. Based upon direct errors in test results or recognized error patterns, the grading module 110 may instruct the audio file manager 104 or video file manager 106 to access one or more tutoring files to provide audio or video feedback to the student on the computing device 100. Such feedback may be provided immediately, and/or at one or more later arising times. The audio and video files may present prerecorded instructions on any topic, such as common mistakes, e.g., “I before e except after c,” etc., and otherwise.

The educational application 102 may utilize a database manager 112 that maintains a test/score database 114. The test/score database may store and include testing files including, but not limited to, records reflecting tests a student has taken, not taken, student scores to tests taken, record concepts identified as needing additional reinforcement, and other data files related to one or more educational related tasks.

The computing device 100 may be coupled to a communication network 135, for example the Internet, through a network interface 116 and connect with one or more remote computing devices, on the Cloud or otherwise, associated with a broader educational platform support for the educational application 102. For a non-limiting example, the computing device 100 may communicate with a server 132 that provides different or additional files, for example, additional tests or instructional videos, which can be used by the educational application 102. The server 132 may be Cloud based. As another non-limiting example, the computing device 100 may communicate with a database 134 and may transfer student performance information thereto. The database 134 may be Cloud based. For example, the test results from the computing device 100 operated by the student may be uploaded to a classroom grading application on the server 132. The server 132 may provide data analytics of the test results in context with the concepts presented in the words tested. The data analytics may be saved on the database 134.

As indicated in FIG. 1, a teacher computer device 182 may communicate with the server 132 to select test modules for provision to students through the educational application 102 and with the database 134 to access student test grades and data analytics. With such access to student performance, teachers can identify concepts that students are struggling with and focus classroom instruction to address such issues.

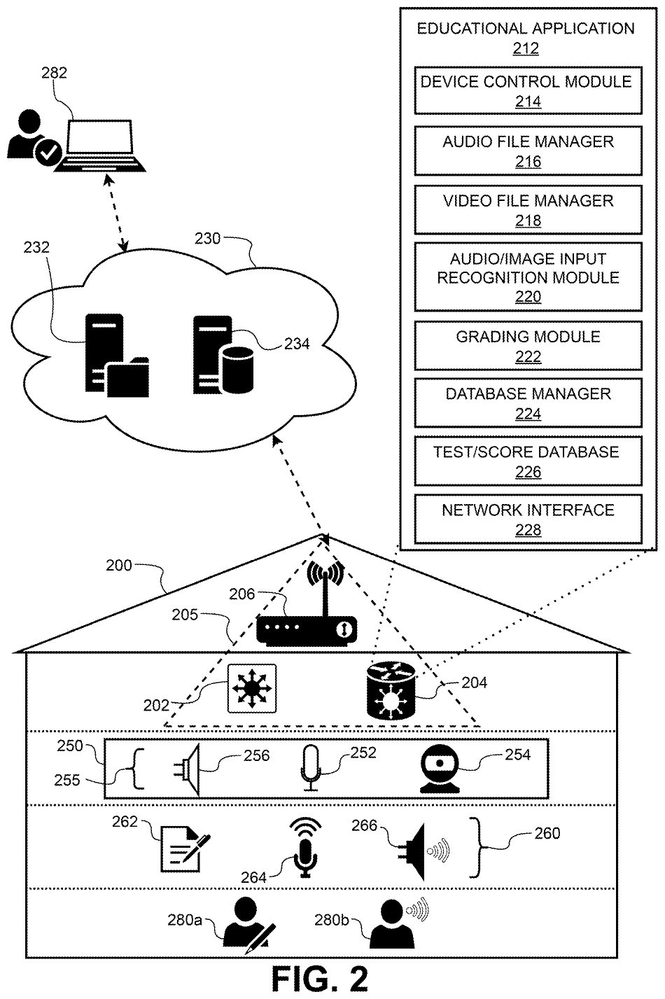

As shown in FIG. 2 and for at least one implementation, a TTAGS can be deployed in a learning environment 200, e.g., in a student's home or school. An educational application 212 may be hosted on a centralized, home-technology management platform, e.g., a gateway device 205. For at least one implementation, the gateway device 205 may include one or more functionalities of a network switch 202, a local device manager 204, and a network access device 206. The educational application 212 may use other connected devices and peripherals in the house (e.g., a living room Bluetooth® speaker to read out the words or a smart-home security camera that the student can hold their finished paper up in front of to “take a picture”). Audible, image, and other data processing capabilities may be provided by the gateway device 205 directly or indirectly, e.g., use Cloud based resources. This eliminates the need for the student to have access to a potentially very distracting computing device (e.g., a smartphone), when they are supposed to be studying.

For at least one implementation, a learning environment 200 may be formed by a switch 202 coupling together two or more computing and “smart” devices 250. Such couplings may occur using, for a non-limiting example, a local area network (LAN) (e.g., one formed using Ethernet or 802.11 wireless protocols). The local device manager 204 may through a network interface 226 communicatively connect with, access, and control a variety of features and functionalities of cooperatively configured computing and smart devices 250 on the LAN. The educational application 212 may further configure the gateway device 205 to create the learning environment 200 on the LAN. In at least one implementation, the local device manager 204 may be an intelligent virtual assistant device such as a smart speaker system (e.g., Amazon® Echo® speakers running Alexa® software or Apple® HomePod® speakers). In other implementations, the local device manager 206 may be incorporated into a gateway device 205, e.g., a mesh wireless router base and satellite system (e.g., Google® Nest® router and speaker devices running Google Home® or Google Assistant software).

The local device manager 204, through the network interface 226 with the LAN, may couple to a remote, wide area, communication network 230, for example, the Internet, and/or the Cloud, through the network access device 206. The communication network 230 may provide access to one or more remote computing devices associated with broader educational platform support for the educational application 212. For a non-limiting example, the local device manager 204 may communicate with a server 232 that provisions the local device manager 204 with the educational application 212 and provides different or additional software and data files. For example, additional tests or instructional videos, for use and presentation by the educational application 212 through computing and smart devices 250 on the LAN, may be provided by the server 232.

Non-limiting examples of computing and smart devices 250 include, smart phones, tablet computers, laptop computers, desktop computers, smart speakers, Internet televisions, smart appliances, security cameras, and other “Internet-of-things” (IOT) devices. Such computing and smart devices 250 may include or be coupled to input/output components 255, e.g., microphones 252, photographic or video cameras 258, and loudspeakers 256. The input/output components 255 may be used by the local device manager 204, under direction of a device control module 214, to provide input and output functionality 260 for the educational application 212. Non-limiting examples of input and output functionality 260 may include character recognition for text input 262 of written test answers, e.g., as captured by a camera 258, speech recognition for oral input 264 of test answers, e.g., as captured by a microphone 252, and audio output 266 by a loudspeaker 256 of test questions to students 280.

For at least one implementation, an audio file manager 216 may access a local library of audio files. One or more of the audio files may be presented, as a list of test words for a student to spell, via a loudspeaker 256 coupled to a selected computing or smart device 250 activated by the device control module 214. The audio file manager 216 could conduct simple oral math quizzes, e.g., by playing simple arithmetic challenges (“What is 2+2?”). A student may answer the spelling or math questions with student visual input 280a by writing answers on a piece of paper. Alternatively, the student may answer the spelling of math question with an audible, oral input 280b.

For at least one implementation, the educational application 212 may include an audio/image recognition module 220. The audio/image recognition module 220 may select one or more networked components to receive a student's answers, schoolwork or other inputs. For example, images of a student's written test results may be captured by a camera 254 coupled to a computing or smart device 250 and provided to the audio/image recognition module 220. The audio/image recognition module 220 can receive audio files that include a student's oral answers, an oral input 280b, as captured by a microphone 252 coupled to the computing or smart device 250. The audio/image recognition module 220 may receive the input data (e.g., test answers) provided by the computing or smart device 250 and manage such input for the purposes of the educational application 212. For example, the audio/image recognition module 220 may process, digitize, and parse the input data for grading and analysis purposes.

For at least one implementation, the educational application 212 may include a video file manager 218 to access, through the device control module 214, a library of instructional videos related to the lessons or concepts being tested. For a non-limiting example, the server 232 may store video files for access by the device control module 214 to stream through a selected computing or smart device 250. Such streaming may occur, e.g., under control of the device control module 214. Such videos may be viewed by the student in advance of taking a test on a particular concept or may be offered to the student upon determination that the student is having difficulty with a concept as indicated by test results.

For at least one implementation, the educational application 212 may include a grading module 222. The grading module 222 may receive the test answers and other input data from the audio/image recognition module 220. The grading module 222 may compare the test answers received to a glossary of the tested words, e.g., by leveraging spell-checking technologies similar to those used in word processing programs. The grading module 222 may include pattern recognition and similar intelligent processing capabilities to identify areas of difficulty exhibited in the nature of student errors in the test answers. Based upon detected errors in test results or recognized error patterns, the grading module 222 may utilize the audio file manager 216 or video file manager 218 to access appropriate tutoring files to provide audio or video feedback to the student on the computing or smart device 250. Such feedback may be provided immediately or otherwise. The audio and video files may present prerecorded instructions regarding common mistakes.

For at least one implementation, the educational application 212 may include a database manager 224. The database manager 224 may interact with a test score database on a database 234 accessible over the communication network 230, the Cloud, or otherwise. The educational application 212 may manage and store a collection of student test information either locally or on the database server 234, on the Cloud, combinations thereof, or otherwise. For example, records stored may include which tests a student has taken or is to take, student scores to tests taken, and concepts identified as needing additional reinforcement, among other information.

For at least one implementation, the local device manager 204 may upload student test results to a classroom grading application on the server 232. The classroom grading application may provide data analytics of the test results in context with the concepts presented in the words tested. The data analytics may be saved on the database 234. As indicated in FIG. 2, a teacher computer device 282 may communicate with the server 232 to select test modules for provision to students through the educational application 212 and the database server 234 to access student test grades and data analytics. With such access to student performance, teachers can identify concepts that students are struggling with and focus classroom instruction to address such issues.

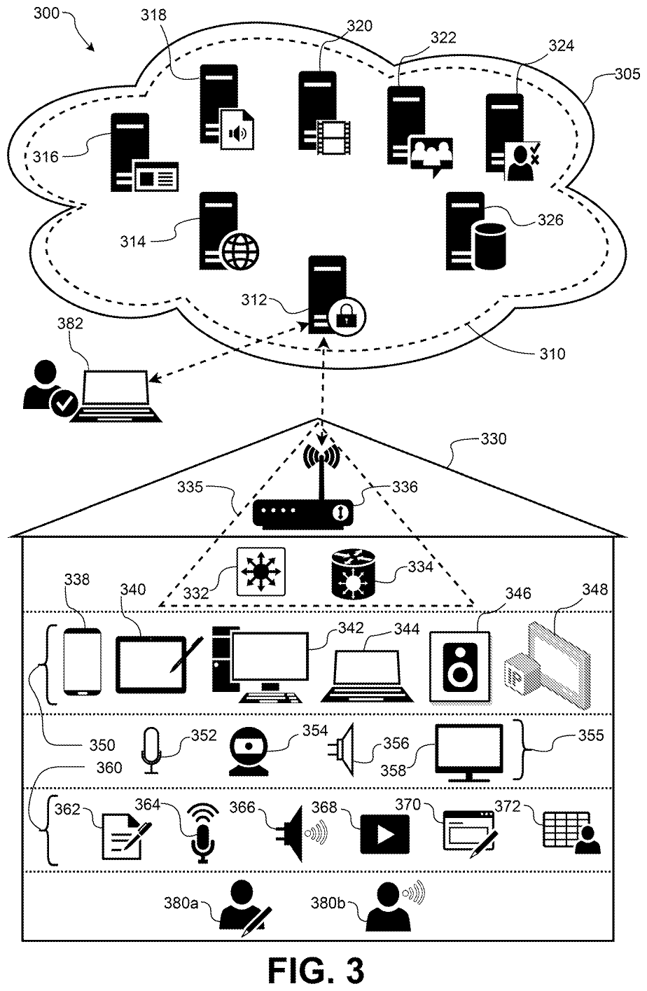

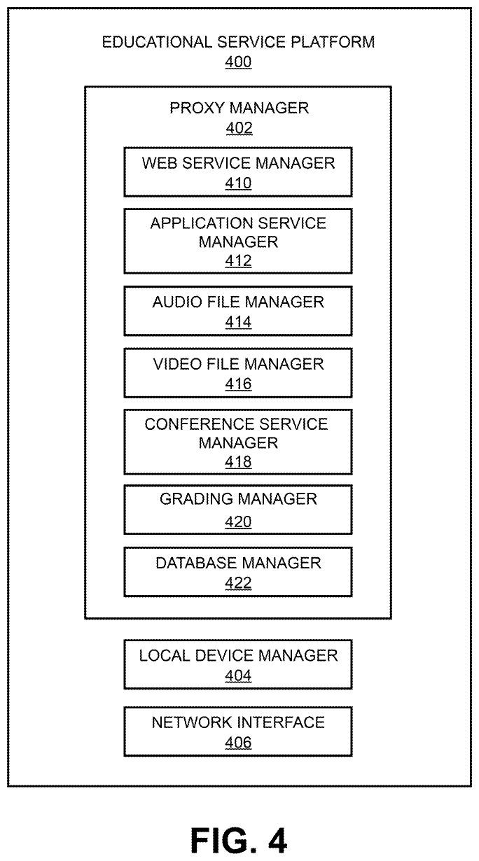

As shown in FIG. 3 and for at least one implementation of the present disclosure, a TTAGS may be deployed in a distributed learning environment 300, e.g., a home or school network 330 coupled with a remote computing network 310. For at least one implementation, such coupling may include use of a wide area network 305, e.g., the Internet. A platform application 400, as depicted in FIG. 4 and described further herein, may coordinate functions of and control interactions between a proxy server 312 and other devices on the remote computing network 308 to interface with and control devices on the home or school network 330.

The proxy server 312 may be controlled by a proxy manager module 402 to act as a gateway to and manager of other devices and services on the remote computing network 310. Such other devices may include, for example, a web server 314, an application server 316, an audio file server 318, a video file server 320, a conference server 322, an intelligent grading server 324, and a database server 326. For at least one implementation, the modules of the platform application 400 may be distributed such that various functional components of the platform application 400 operate on different devices of the remote computing network 310 pursuant to the direction of proxy manager module 402 running on the proxy server 312. The proxy server 312 may include a local device manager module 404 to communicate with and control, via a network interface 406, devices on student home or school networks 330 to interface to create the distributed learning environment 300. Additionally, respective network interfaces may couple two or more of the proxy server 312, the web server 314, the application server 316, the audio file server 318, the video file server 320, the conference server 322, the intelligent grading server 324, the database server 326, and the home or school networks 330.

A centralized, home-technology management platform e.g., a gateway device 335, may operate in cooperation with the proxy server 312 on the home or school network 330. The gateway device 335 may communicate with and receive commands from the proxy server 312 to access and leverage computing or smart devices 250 on the home or school network 330. For at least one implementation, the gateway device 335 may be a device that combines the functionality of a network switch 332, a local device manager 334, and a network access device 336. In other implementations, these devices may be separate and operate cooperatively to provide the functionality of a gateway device 335. The platform application 400 may use computing and smart devices 350 connected to the home or school network 330 to interact with a student and provide the educational services. However, the primary processing of information may be provided by the various server computers on the remote computing network 310.

The computing and smart devices 350 may be coupled together in a local area network (LAN) (e.g., using Ethernet or 802.11 wireless protocols) by the network switch 332 to form the distributed learning environment 300. The local device manager 334 may through a network interface communicatively connect with, access, and control a variety of features and functionalities of cooperatively configured computing and smart devices 350 on the LAN. The platform application 400 may configure the gateway device 335 and local device manager 334 to leverage the LAN network to become an active part of the distributed learning environment 300. In at least one implementation, the local device manager 334 may be an intelligent virtual assistant device such as a smart speaker system (e.g., Amazon® Echo® speakers running Alexa® software or Apple® HomePod® speakers). In other implementations, the local device manager 334 may be incorporated into a gateway device 335, e.g., a mesh wireless router base and satellite system (e.g., Google® Nest® router and speaker devices running Google Home® or Google Assistant software).

Non-limiting examples of computing and smart devices 350 on the home or school network 330 may include smart phones 338, tablet computers 340, desktop computers 342, laptop computers 344, smart speaker 346, Internet televisions 348, video gaming devices, smart appliances, security cameras, and other “Internet-of-things” (IOT) devices. Such computing and smart devices 350 may include or be connected to input/output components 355, e.g., microphone 352, photographic and video cameras 354, loudspeakers 356, and video screens or monitors 358. These input/output components 355 may be accessed and marshalled for use in the distributed learning environment 300 by the local device manager 334 under direction of the platform application 400 to provide input and output functionality 360 to and from the students 380 interfacing with the home or school network 330. Examples of input and output functionality 360 may include character recognition for text input 362 of written test answers, e.g., captured by a camera 354, speech recognition for oral input 364 of test answers, e.g., captured by a microphone 352, and audio output 366 provided by a loudspeaker 356 to present test questions to students 380.

Another example of input and output functionality 360 may include audio/video presentations 368 to provide instruction or tutoring via a video screen or monitor 358 and loudspeaker 356 on any of the computing or smart devices 350. A further example of input and output functionality 360 may include interactive applications 370 accessible on any of the computing or smart devices 350 for instruction, tutoring, and receipt of typed input as answers to quiz questions presented audibly. Yet another example of input and output functionality 360 may include an audio/video conference platform 372 accessible on any of the computing or smart devices 350 for live instruction and tutoring by a teacher remotely through a teacher computing device 382.

The gateway device 335 may be provisioned with additional software functionality (e.g., received from the proxy server 312) to operate in cooperation with the proxy server 312 on the home or school network 330 and control the computing and smart devices 350 to implement a TTAGS. Further, the proxy server 312 may harness the functionality of the other devices on the remote computing network 310 to implement the TTAGS in a distributed environment. For example, a web service manager module 410 may operate on the web server 314 to provide an interface for a student or teacher to interact with the platform application 400 within the distributed learning environment 300 using a computing or smart device 350 on the home or school network 330. Through the interface provided by the web server 314, the student 380 (or parent) may select one or more testing or instruction modules from a list of options presented in the interface for evaluation of skills and understanding. Such tests and modules may be assigned by the teacher or may be generally available for access.

Such selection of a test or instruction module, in one example implementation, may be conveyed by the web service manager module 410 to one or more other devices on the remote computing network 310. For example, a request by a student or teacher might be relayed to the application server 316 under the control of an application service manager module 412. The application server 316 may be directed by the application service manager module 412 to download an instructional or testing application for instantiation on a computing or smart device 350 on the home or school network 330, e.g., to provide for offline instruction or testing via the computing or smart device 350.

In another example, the audio file server 318 under the control of an audio file manager module 414 may store and access a library of audio files and provide selected audio files, e.g., by streaming audio segments, to a computing or smart device 350 on the home or school network 330. The audio segments may be, for example, quiz questions such as words for spelling or tutoring feedback. The audio file manager module 414 may work in cooperation with input/output components 355 on the selected computing or smart device 350, e.g., a loudspeaker 356 or smart speaker 346 which a student has orally engaged for provision of a spelling session. The audio file server 318 may be configured to receive audible form of a student oral input 380b from a microphone 352 on the computing or smart device 350 reflecting quiz answers. The student oral input 380b may be digitized and transmitted by the gateway device 335 as an audio file or live streamed to the audio file server 318, which may be configured to perform speech recognition analysis on the audio files received. The answers contained in the audio files from the student oral input 380b may be parsed for grading quiz performance and for identification of areas for further instruction or tutoring.

Similarly, the video file server 320 under the control of a video file manager module 416 may store and access a library of video files and provide selected video files, e.g., by streaming video segments, to a computing or smart device 350 on the home or school network 330. The video segments may be, for example, quiz questions such as math problems or they may be instructional or tutoring audio-video segments related to the lessons or concepts being tested for presentation to a student. Such video segments may be viewed by the student in advance of taking a test on a particular concept or may be offered to the student upon determination that the student is having difficulty with a concept as indicated by test results. The video file manager module 416 may work in cooperation with input/output components 355 on the selected computing or smart device 350, e.g., a video screen or monitor 358 and a loudspeaker 356 on a chosen computing or smart device 350 which a student has engaged for provision of a quiz or tutoring session. The video file server 320 may be configured to receive student visual input 380a from a photographic or video camera 354 on the computing or smart device 350 showing written quiz answers, e.g., on a piece of paper. The student visual input 380a may be transmitted by the gateway device 335 as an image file or live streamed to the video file server 320, which may be configured to perform handwriting recognition analysis on the image files received. The answers contained in the image files from the student visual input 380a may be used for grading quiz performance and identification of areas for further instruction or tutoring.

The conference server 322 may be managed by a conference service manager module 418 to provide audio-video conferences between a teacher computing device 382 and any of the computing or smart devices 350 on the home or school network 330. Audio-video conferences may be used to provide live instruction and tutoring between a teacher and one or more students logged in to an audio-video conference session managed by the conference server 322.

The intelligent grading server 324 may be managed by a grading manager module 420 that may interact with the audio file server 318 and the video file server 320 to receive the test answers and other input data from students. The grading manager module 420 may compare the test answers received to a glossary of the tested words, e.g., by leveraging spell-checking technologies similar to those used in word processing programs. Additionally, the grading manager module 420 may include pattern recognition and similar intelligent processing capabilities to identify areas of difficulty exhibited in the nature of student errors in the test answers. The grading manager module 420 may interact with a test score database implemented by a database manager module 422 on the database server 326. The grading manager module 420 may send a collection of student test information, for example, records of which tests a student takes, student scores to tests taken, and concepts identified as needing additional reinforcement, among other information, to the database server 326 for organization and storage by the database manager module 422.

In another non-limiting example implementation, the grading manager module 420 on the intelligent grading server 324 may provide data analytics of the test results in context with the concepts presented in the subject matter tested (e.g., spelling of words, arithmetic problems). The data analytics may be saved on the database server 326. As indicated in FIG. 3, a teacher computer device 382 may communicate with the proxy server 312 to select test modules from the audio file server 318 or the video file server 320 for provision to students on the home or school network 330. The teacher computer device 382 may connect to the database server 326 to access student test grades and data analytics. With such access to student performance, teachers can identify concepts that students are struggling with and focus classroom instruction or select video tutorials from the video file server 320 to assign to students to address such issues.

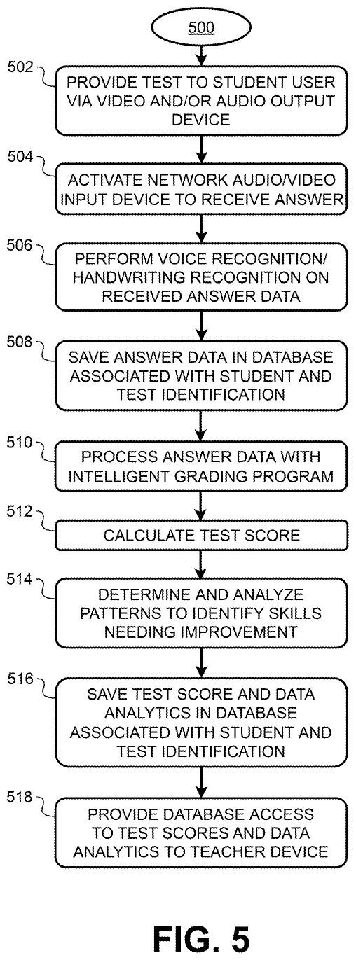

FIG. 5 shows, for at least one implementation of the present disclosure, a method 500 for providing a TTAGS by any of the system implementations described herein. The method 500 may begin in a providing operation 502 with provision of a test or quiz to a student user via video and/or audio output on a computing or smart device on a home or school network. In an activating operation 504, a computing or smart device on the home or school network may be activated to receive audio or video input of answers to the test or quiz questions. As described above, the student answers may be written text answers captured by a camera on a computing or smart device or an audible oral answer captured by a microphone on a computing or smart device.

In a performing operation 506, voice recognition or handwriting recognition may be performed, respectively, on received audio or video files of student answers to questions. In a saving operation 508, the recognized answers may be stored in a database associated with student identification and test identification information. In a processing operation 512, the answer data may be processed by an intelligent grading program to compare student answers with correct answers, e.g., by using a spellcheck algorithm or by accessing answers in a lookup table. In a calculating operation 510, a test score indicating the student's performance on the particular test may be calculated based upon the output of the intelligent grading program. In a determining operation 514, the student's answers may be analyzed to determine patterns and prepare data analytics of the test results in context with the concepts presented in the subject matter tested, e.g., to identify skills and concepts needing additional reinforcement.

In a saving operation 516, the test scores, performance metrics, and data analytics may be saved in a database associated with the student and test identification information. Finally, in a providing operation 518, the test scores, performance metrics, and data analytics may be made available for access by a teacher computing device for review and consideration by a teacher. The teacher can use the stored test scores for entry into a gradebook and also review the data analytics to identify areas of concern and skills needing improvement to inform future lesson plans and assignments for additional practice.

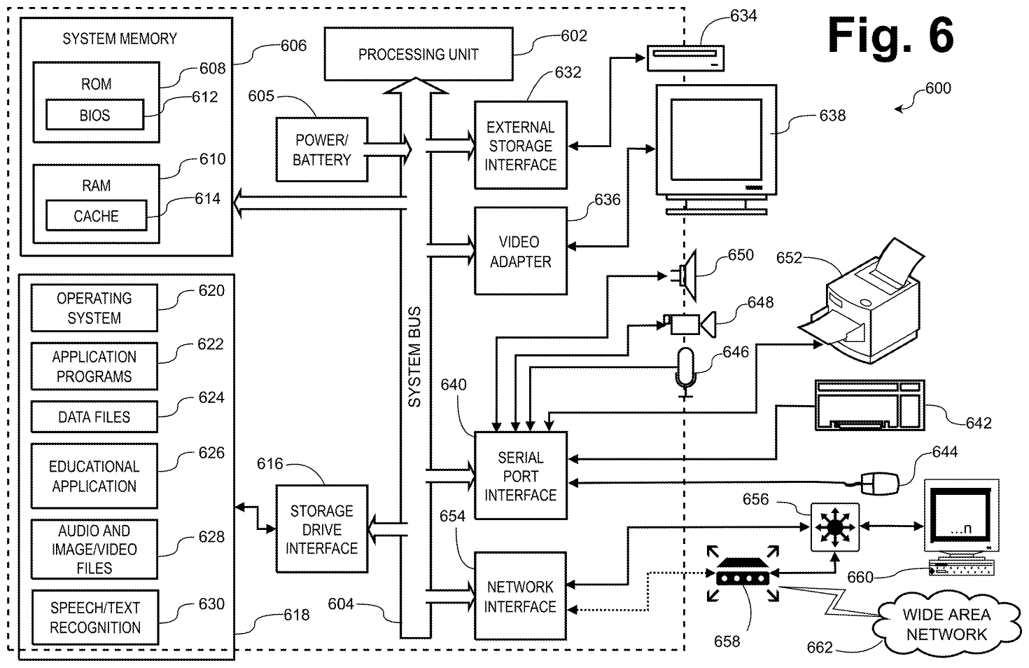

In FIG. 6, and for at least one implementation of the present disclosure, a computer system 600 implementing the processes performed as part of an educational tutoring, testing, and auto-grading application, environment, or platform as described above is depicted. The computer system 600 may be special purpose computer device, or it may be one or more of a personal computer (PC), a workstation, a notebook or portable computer, a tablet computer, a smart phone device, a video gaming device, a server computer, a smart or IOT device, or other computer device, with internal processing and memory components as well as interface components for connection with external input, output, storage, network, and other types of peripheral devices, particularly configured to perform the functions described herein. Alternatively, the computer system 600, for example, may be in the form of any of a server, a virtual machine instantiated on a server, a distributed computer, an Internet appliance, or other computer devices, or combinations thereof. Internal components of the computer system 600 in FIG. 6 are shown within the dashed line and external components are shown outside of the dashed line. Components that may be internal or external are shown straddling the dashed line.

In at least one implementation described herein, the computer system 600 includes a processor 602 and a system memory 606 connected by a system bus 604 that also operatively couples various system components. There may be one or more processors 602, e.g., a central processing unit (CPU), or a plurality of processing units, commonly referred to as a parallel processing environment (for example, a dual-core, quad-core, or other multi-core processing device).

“Processor” refers to one or more known or later developed hardware processors and/or processor systems configured to execute one or more computer instructions, with respect to one or more instances of data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64 bit central processing units; multi-core ARM based processors; microprocessors, microcontrollers; and the like. Processors may be implemented in single or parallel or other implementation structures, including distributed, Cloud based, and otherwise The processor 602 is configured to execute instructions with respect to data.

“Data” (which is also referred to herein as a “computer data” and “data packet(s)”) refers to any representation of facts, information, or concepts in a form suitable for processing by one or more electronic device processors and which, while and/or upon being processed, cause or result in an electronic device or other device to perform at least one function, task, operation, provide a result, or otherwise. Data may exist in a transient and/or non-transient form, as determined by any given use of the data

“Instruction” (which is also referred to herein as a “computer instruction”) refers to a non-transient processor executable instruction, associated data structure, sequence of operations, program modules, or the like. An instruction is defined by an instruction set. It is commonly appreciated that instruction sets are often processor specific and accordingly an instruction may be executed by a processor in an assembly language or machine language format that is translated from a higher level programming language. An instruction may be provided using any form of known or later arising programming; non-limiting examples including declarative programming, imperative programming, functional programming, procedural programming, stack based programming, object-oriented programming, and otherwise.

A “computer engine” (or “engine”) refers to a combination of a “processor” and “computer instruction(s).” A computer engine executes computer instructions to perform one or more logical operations (herein, a “logic”) which facilitate various actual (non-logical) and tangible features and functions provided, in whole or in part, by an electronic device.

The system bus 604 may be any of type of bus structures including a memory bus or memory controller, a peripheral bus, a switched-fabric, point-to-point connection, and a local bus using any of a variety of bus architectures. The computer system 600 may include a power source 605, e.g., either or both an electrical port for connecting to an AC/DC inverter for constant power or a battery for working without a connected power source or for provision of backup power in a case of general or local power outage or emergency.

The system memory 606 includes read only memory (ROM) 608 and random access memory (RAM) 610. A basic input/output system (BIOS) 612, containing the basic routines that help to transfer information between elements within the computer system 600, such as during start-up, is stored in ROM 608. A cache 614 may be set aside in RAM 610 to provide a high-speed memory store for frequently accessed data.

A storage drive interface 616 may be connected with the system bus 604 to provide read and write access to a data storage drive 618, e.g., a magnetic hard disk drive or a solid-state drive for nonvolatile storage of applications, files, and data. Program modules and other data may be stored on the data storage drive 618, including an operating system 620, one or more application programs 622, and related data files 624. In particular, an educational application 626, or modules thereof, for implementing a tutoring, testing, and auto-grading process and system may be stored on the data storage drive 618. In addition, audio and image/video files 628 may be stored in the data storage drive 618. Further, handwriting and voice recognition algorithms 630 may be stored in the data storage drive for access by the educational application 626. Note that the data storage drive 618 may be either an internal component or an external component of the computer system 600 as indicated by the data storage drive 618 straddling the dashed line in FIG. 6.

At least one implementation may include an internal and an external storage drive. For example, one or more external storage drives 634 may be connected with the system bus 604 via an external storage interface 632 to provide read and write access to the external storage drive 634 initiated by other components or applications within the computer system 600. External storage drives may also be connected to the system bus 604 via a serial port interface 640 further described below. Exemplary external storage drives 634 may include a magnetic disk drive for reading from or writing to a removable magnetic disk, tape, or other magnetic media, and/or an optical disk drive for reading from or writing to a removable optical disk such as a CD-ROM, a DVD, or other optical media. The external storage drive 634 and any associated removable computer-readable media may be used to provide nonvolatile storage of computer-readable instructions, data structures, program modules, and other data for the computer system 600.

The computer system 600 may include a video screens 638, e.g., a display screen, a monitor, a television, or a projector, or other type of presentation device connected to the system bus 604 via an interface, such as a video adapter 636 or a video card. The computer system 600 may also include other peripheral input and output devices, which are often connected to the processor 602 and memory 606 through the serial port interface 640 that is coupled to the system bus 604. Input and output devices may also or alternately be connected to the system bus 604 by other interfaces, for example, a universal serial bus (USB), an IEEE 1394 interface (“Firewire”), a parallel port, or a game port, or wirelessly e.g., using a Bluetooth® connection interfacing with the serial port interface 640 or system bus 604. A user may enter commands and information into the computer system 600 through various input devices including, for example, a keyboard 642 and pointing device 644, for example, a computer mouse. Other input devices may include, for example, a microphone 646 and a digital video camera 648, or (not shown) a digital camera, a joystick, a game pad, a tablet, a touch screen device, a satellite dish, a scanner, or a facsimile machine.

Output devices may include one or more loudspeakers 650 for presenting the test questions audibly to a student or video screens 638 for presenting instruction to a student. Audio devices, for example, loudspeakers 650 or a microphone 646, may alternatively be connected to the system bus 604 through an audio card or other audio interface (not shown). Other output devices may include, for example, a printer 652, or (not shown) a plotter, a photocopier, a photo printer, a facsimile machine, and a press. In at least one implementation, input and output devices may be combined into single devices, for example, a printer/scanner/fax/photocopier. Other types of computer-readable media and associated drives for storing data, for example, magnetic disks or flash memory drives, may be accessed by the computer system 600 via the serial port interface 640 (e.g., USB) or similar port interface.

The computer system 600 may operate in a networked environment using logical connections through a network interface 654 coupled with the system bus 604 to communicate with one or more remote devices. The logical connections depicted in FIG. 6 include a local-area network (LAN) 656 and a wide-area network (WAN) 662. Such networking environments are commonplace in home networks, office networks, enterprise-wide computer networks, and intranets. These logical connections may be achieved by a network access device 658 coupled to or integral with the computer system 600. As depicted in FIG. 6, the network access device 658 may operate as both a wireless router for directing traffic on the LAN 656 or may connect with a switch or hub (the physical structure of the LAN 656), either wired or wireless, internal or external, to connect with remote devices, e.g., a remote computer 660, similarly connected on the LAN 656. The remote computer 660 may be another personal computer, a server, a client, a peer device, or other common network node, and typically includes one or more of the elements described above relative to the computer system 600.

To connect the computer system 600 with a WAN 662, the network access device typically includes a modem for establishing communications over the WAN 662. However, in at least one implementation, the modem for external network connections and the router for local network connections may be separate components. Most often the WAN 662 may be the Internet. However, the WAN 662 may be a large private network spread among multiple locations, or a virtual private network (VPN). The modem component of the network access device 658 may be a telephone modem, a high-speed modem (e.g., a digital subscriber line (DSL) modem), a cable modem, or similar type of communications device. The network access device 658 with modem is connected to the system bus 604 via the network interface 654. In alternate embodiments the network access device 658 may be connected via the serial port interface 640. The network connections shown are exemplary and other means of and communications devices for establishing a network communications link between the computer system 600 and other devices or networks may be used.

The terms “module,” “program,” and “engine” may be used to describe one or more of a hardware component, a software process, or a combination of both, that implement logical operations and/or algorithms to perform a particular function. It will be understood that different modules, programs, and/or engines refer to discrete components of software code that may perform independent subroutines, tasks, or calculations by implementing one or more algorithms and together perform the functions of the larger application. Modules, programs, or engines may be called upon instantiated by one or more applications, services, code blocks, objects, libraries, routines, scripts, application program interfaces (API), functions, etc. When incorporating software, the modules, programs, and engines may encompass individual or groups of executable files, data files, libraries, drivers, scripts, database records, etc. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Furthermore, logical operations may be performed in any order, unless explicitly claimed otherwise or a specific order is inherently necessitated by the claim language.

In at least one implementation, articles of manufacture are provided as computer program products that cause the instantiation of operations on a computer system to implement the procedural operations. One implementation of a computer program product provides a non-transitory computer program storage medium readable by a computer system and encoding a computer program. The described technology may be employed in special purpose devices independent of a personal computer.

Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to another element. The exemplary drawings are for the purpose of illustration and the dimensions, positions, order and relative sizes reflected in the drawings attached hereto may vary.

The above specification, examples and data describe structures and uses of one or more implementations of the present disclosure. Although various implementations have been described above with a certain degree of particularity, other implementations using different combinations of elements and structures disclosed herein are contemplated, as other iterations can be determined through ordinary skill based upon the teachings of the present disclosure. It is intended that matters contained in the above description and shown in the accompanying drawings shall be interpreted as illustrative of particular implementations and not limiting. Changes in detail or structure may be made without departing from the basic elements of the invention as defined in the following claims.

What is claimed is:

1. A method implemented within a computer network for providing an educational service, the method comprising:
controlling a first device connected within the computer network to present a test question using an output component of the first device;
controlling either the first device or a second device connected within the computer network to receive a response to the test question using an input component of either the first device or the second device;
transforming the received response by the input component into a digital file;
applying a recognition algorithm to the digital file of the received response to parse the received response; and
processing the parsed received response to determine an accuracy of the response to the test question.

2. The method of claim 1 further comprising:
calculating a grade corresponding to the determined accuracy of the response to the test question.

3. The method of claim 1 further comprising:
storing a plurality of parsed received responses in a non-transitory storage medium as a collection of parsed received responses;
analyzing the collection of parsed received responses to identify patterns indicating poor understanding of a skill; and
providing a tutoring presentation.

4. The method of claim 1,
wherein the output component further comprises a loudspeaker; and
wherein the test questions are presented as audible output from the loudspeaker.

5. The method of claim 1,
wherein the output component further comprises a video screen; and
wherein the test questions are presented in an image in the video screen.

6. The method of claim 1,
wherein the input component further comprises a microphone;
wherein the test answers are received as an audible response; and
wherein the recognition algorithm comprises a speech recognition algorithm.

7. The method of claim 1,
wherein the input component further comprises a camera;
wherein the test answers are received as an image of a written response; and
wherein the recognition algorithm comprises a handwriting recognition algorithm.

8. A system for providing an educational service on a computer network comprising:
a computing processor;
a memory storage device that stores instructions for directing the computing processor to execute a control algorithm including:
a device control module stored in the memory storage device and executable by the computing processor that configures the system to:
control a first computing or smart device connected within the computer network to present a test question using an output component of the computing or smart device; and
control either the first computing or smart device or a second computing or smart device connected within the computer network to receive a response to the test question using an input component of either the first or second computing or smart device;
a file manager module stored in the memory storage device and executable by the computing processor that configures the system to transform the received response by the input component into a digital file;
a recognition module stored in the memory storage device and executable by the computing processor that configures the system to apply a recognition algorithm to the digital file of the received response to parse the received response; and
a grading module stored in the memory storage device and executable by the computing processor and configured to process the parsed received response to determine an accuracy of the response to the test question.

9. The system of claim 8,
wherein the grading module further configures the system to calculate a grade corresponding to the determined accuracy of the response to the test question.

10. The system of claim 8 further comprising:
a database module stored in the memory storage device and executable by the computing processor that configures the system to store a plurality of parsed received responses in a non-transitory storage medium as a collection of parsed received responses; and
wherein the grading module further configures the system to:
analyze the collection of parsed received responses to identify patterns indicating poor understanding of a skill; and
provide a tutoring presentation by leveraging the file manager module to provide the tutoring presentation and leveraging the device control module to control either the first computing or smart device or the second computing or smart device to present the tutoring presentation on either the first computing or smart device or the second computing or smart device.

11. The system of claim 8,
wherein the output component further comprises a loudspeaker and the test questions are presented as audible output from the loudspeaker.

12. The system of claim 8,
wherein the output component further comprises a video screen and the test questions are presented in an image in the video screen.

13. The system of claim 8,
wherein the input component further comprises a microphone and the test answers are received as an audible, oral response; and
wherein the recognition algorithm comprises a speech recognition algorithm.

14. The system of claim 8,
wherein the input component further comprises a camera and the test answers are received as an image of a written response; and
wherein the recognition algorithm comprises a handwriting recognition algorithm.

15. A tangible processor-readable storage media embedded with instructions for executing a process on a computing device to provide an educational service, the process comprising:
controlling a first computing or smart device connected within a local area network to present a test question using an output component of the computing or smart device;
controlling either the first computing or smart device or a second computing or smart device connected within the local area network to receive a response to the test question using an input component of either the first or second computing or smart device;
transforming the received response by the input component into a digital file;
applying a recognition algorithm to the digital file of the received response to parse the received response; and
processing the parsed received response to determine an accuracy of the response to the test question.

16. The tangible processor-readable storage media of claim 15,
wherein the process further comprises calculating a grade corresponding to the determined accuracy of the response to the test question.

17. The tangible processor-readable storage media of claim 15,
wherein the process further comprises:
storing a plurality of parsed received responses in a non-transitory storage medium as a collection of parsed received responses;
analyzing the collection of parsed received responses to identify patterns indicating poor understanding of a skill; and
providing a tutoring presentation.

18. The tangible processor-readable storage media of claim 15,
wherein the output component further comprises one of a loudspeaker or a video screen; and
wherein the test questions are presented as audible output from the loudspeaker or in an image in the video screen.

19. The tangible processor-readable storage media of claim 15,
wherein the input component further comprises a microphone and the test answers are received as an audible, oral response; and
wherein the recognition algorithm comprises a speech recognition algorithm.

20. The tangible processor-readable storage media of claim 15,
wherein the input component further comprises a camera and the test answers are received as an image of a written response; and
wherein the recognition algorithm comprises a handwriting recognition algorithm.
